(19) United States
(12) Patent Application Publication
(10) Pub. No.: US 2026/0105229 A1
(43) Pub. Date: Apr. 16, 2026

(54) MULTIPLE INPUT, MULTIPLE OUTPUT COMPILER FOR PREPARING FILES FOR DESIGN OF A HARDWARE-SOFTWARE INTERFACE IN AN ELECTRONIC SYSTEM

(71) Applicant: ARTERIS, INC., Campbell, CA (US)

(72) Inventors: Tim SCHNEIDER, Phoenix, AZ (US); Richard WEBER, Mountain View, CA (US)

(73) Assignee: ARTERIS, INC., Campbell, CA (US)

(21) Appl. No.: 19/357,070

(22) Filed: Oct. 13, 2025

Related U.S. Application Data
(60) Provisional application No. 63/706,577, filed on Oct. 11, 2024.

(51) Int. Cl. G06F 30/31; G06F 115/02; G06F 117/08

(52) U.S. Cl. CPC G06F 30/31; G06F 2115/02; G06F 2117/08

(57) ABSTRACT

A computer-implemented method for electronic computer-aided design of an electronic system includes collecting a plurality of input files from a corresponding plurality of multiple sources in different formats. The input files describe a hardware/software interface in an electronic system. The method further includes building an internal model of hardware/software behavior combinations of the hardware/software interface, including mapping data in the input files to the internal model; and verifying that the internal model is self-consistent and correct.

### CROSS REFERENCE TO RELATED APPLICATION

This application claims the benefit under 35 U.S.C. 119(e) of US Provisional Application Serial No. 63/706,577 filed on October 11, 2024 and titled SYSTEM AND METHOD FOR OPTIMIZATION OF THE DESIGN AND THE IMPLEMENTATION OF A SYSTEM-ON-CHIP AND A NETWORK-ON-CHIP by Tim Schneider et al., the entire disclosure of which is incorporated herein by reference.

### FIELD

The present technology is in the field of electronic computer-aided design of integrated circuits and, more specifically, related to the design of a system on chip (SoC) and network-on-chip (NoC).

### BACKGROUND

Network-on-chip technology is being used at many semiconductor companies to support an ever-increasing number of cores on a single chip and a demand for ever-increasing processing power related to artificial intelligence (AI) and other applications. A NoC is superior to point-to-point connectivity by way of a more scalable communication architecture that makes use of packet transmissions.

An SoC may include a NoC to handle communication between Intellectual Property (IPs) s of the SoC. The IPs include initiators and targets. When an initiator sends a request transaction to a target, the NoC receives the transaction, decodes an address in the request transaction, and transports the request transaction to the target at the address. The target may send a response transaction back to the initiator via the NoC. The NoC sends the transactions according to a transport protocol that is typically based on the transmission of packets.

The SoC may include a number of hardware/software interfaces such as control and status registers (CSRs). CSRs are commonly used in initiators such as processors (e.g., CPUs and microcontrollers) for reading status and changing configuration. CSRs are also used in the NoC.

During development of an SoC, many disciplines are involved: chip architecture design, software development, RTL design, RTL verification, and documentation. Miscommunication with respect to the hardware/software interfaces can lead to specification misalignment. Specification misalignment, in turn, can result in late fixes or even re-spins.

Chances of specification misalignments are increased by scale. An SoC might have millions of hardware/software interfaces.

### SUMMARY

In accordance with various embodiments and aspects herein, a computer-implemented method for electronic computer-aided design of an electronic system includes collecting a plurality of input files from a corresponding plurality of multiple sources in different formats. The input files describe a hardware/software interface in an electronic system. The method further includes building an internal model of hardware/software behavior combinations of the hardware/software interface, including mapping data in the input files to the internal model; and verifying that the internal model is self-consistent and correct.

In accordance with various embodiments and aspects herein, a computer system includes a processing unit; and computer-readable memory encoded with code that, when executed by the processing unit, causes the computer system to receive a plurality of input files about design of an electronic system including a plurality of hardware/software interfaces (HSIs); build an internal model of hardware/software behavior combinations of the HSIs, including mapping data in the input files to the internal model; and verify that the internal model is self-consistent and correct.

In accordance with various embodiments and aspects herein, a compiler is within a tool for implementation and design of a system-on-chip and a network-on-chip. The tool includes a non-transitory computer readable medium for storing code, which when executed by one or more processors, causes the tool to receive, as input, data about control and status registers (CSRs), including at least access permissions, reset values, and properties. The code, when executed, further causes the tool to generate register transfer level (RTL) code for the CSRs; generate documentation that details register map and configuration settings for the CSRs; and integrate the RTL code into an SoC design and NoC design. The tool ensures compatibility with memory maps, and generates components for RTL verification.

### BRIEF DESCRIPTION OF THE DRAWINGS

In order to understand the invention more fully, a reference is made to the accompanying drawings. The invention is described in accordance with the aspects and embodiments in the following description with reference to the drawings or figures(FIG.), in which like numbers represent the same or similar elements. Understanding that these drawings are not to be considered limitations in the scope of the invention, the presently described aspects and embodiments and the presently understood best mode of the invention are described with additional detail through the use of the accompanying drawings.

FIG. 1 shows an example of an electronic system SoC including a NoC.

FIG. 2 shows a hardware/software interface for an electronic system.

FIG. 3 shows a method of generating a hardware description of a NoC for an SoC in accordance with various aspects and embodiments herein.

FIG. 4 shows a multiple-input, multiple-output compiler in accordance with various aspects and embodiments herein.

FIG. 5 shows a method performed by a multiple-input, multiple-output compiler in accordance with various aspects and embodiments herein.

FIG. 6 shows a computer system including a multiple-input, multiple-output compiler in accordance with various aspects and embodiments herein.

### DETAILED DESCRIPTION

The following describes various examples of the present technology. Generally, examples can use the described aspects in any combination. All statements herein reciting principles, aspects, and embodiments as well as specific examples thereof, are intended to encompass both structural and functional equivalents thereof. Additionally, it is intended that such equivalents include both currently known equivalents and equivalents developed in the future, i.e., any elements developed that perform the same function, regardless of structure.

It is noted that, as used herein, the singular forms “a,” “an” and “the” include plural referents unless the context clearly dictates otherwise. Reference throughout this specification to “one embodiment,” “an embodiment,” “certain embodiment,” “various embodiments,” or similar language means that a particular aspect, feature, structure, or characteristic described in connection with the embodiment is included in at least one embodiment.

Thus, appearances of the phrases “in one embodiment,” “in at least one embodiment,” “in an embodiment,” "in certain embodiments," and similar language throughout this specification may, but do not necessarily, all refer to the same embodiment or similar embodiments. Furthermore, aspects and embodiments described herein are merely exemplary, and should not be construed as limiting of the scope or spirit of the invention as appreciated by those of ordinary skill in the art. All statements herein reciting principles, aspects, and embodiments are intended to encompass both structural and functional equivalents thereof. It is intended that such equivalents include both currently known equivalents and equivalents developed in the future. Furthermore, to the extent that the terms "including", "includes”, “having", "has", "with", or variants thereof are used in either the detailed description and the claims, such terms are intended to be inclusive in a similar manner to the term "comprising."

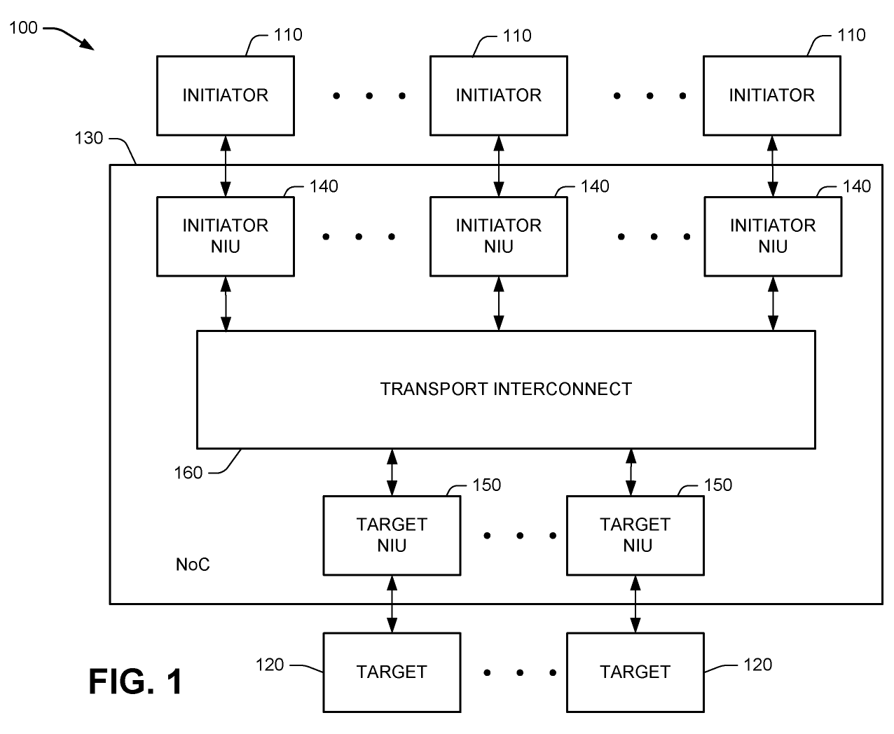

Reference is made to FIG. 1, which illustrates a simple example of an SoC 100 including a plurality of initiators 110 and targets 120. Examples of the initiators 110 include central processing units (CPUs), graphics processing units (GPUs), video cards, accelerators, and direct memory access (DMA) controllers. Examples of the targets 120 include volatile memory, persistent memory, and peripherals.

The SoC 100 further includes a NoC 130. The NoC 130 sends request transactions from an initiator 110 to one or more targets 120 using industry-standard protocols. A request transaction includes an address of the target 120. The NoC 130 receives a request transaction from an initiator 110, decodes the address, and transports the request transaction to the target 120, which handles the request transaction. A target 120 may respond with a response transaction, which is transported back to the initiator 110 via the NoC 130.

The NoC 130 includes a plurality of network interface units (NIUs) 140 and 150 and a transport interconnect 160. Each initiator 110 is coupled to the transport interconnect 160 via a corresponding initiator NIU 140. Each target 120 is coupled to the transport interconnect 160 via a corresponding target NIU 150.

Each initiator NIU 140 is configured to convert the protocol used by its corresponding initiator 110 into a transport protocol that is used inside the NoC 130. Each target NIU 150 is configured to convert the protocol used by its corresponding target 120 into a transport protocol that is used inside the NoC 130. The transport protocol is typically based on the transmission of packets.

The transport interconnect 160 transports packets between the initiator NIUs 140 and the target NIUs150. The transport interconnect 160 includes switches, adapters, and buffers. Switches may be used to route flows of traffic between sources and destinations. Adapters may be used to deal with various conversions between data width, clock domains, and power domains. Buffers may be used to insert pipelining elements to span long distances, or to store packets to deal with rate adaptation between fast senders and slow receivers or vice-versa.

The SoC 100 includes a number of hardware/software interfaces (HSIs). One example of an HSI is a control and status register (CSR). CSRs are commonly used in initiators 110 such as processors (e.g., CPUs and microcontrollers) for reading status and changing configuration. Properties of CSRs typically include name, description, address, field layout, reset value, and access type.

The NoC 130 also includes a number of HSIs such as CSRs. The NoC 130 may use CSRs for managing communication and data flow within. These CSRs typically store information about routing decisions, flow control, and status of communication channels.

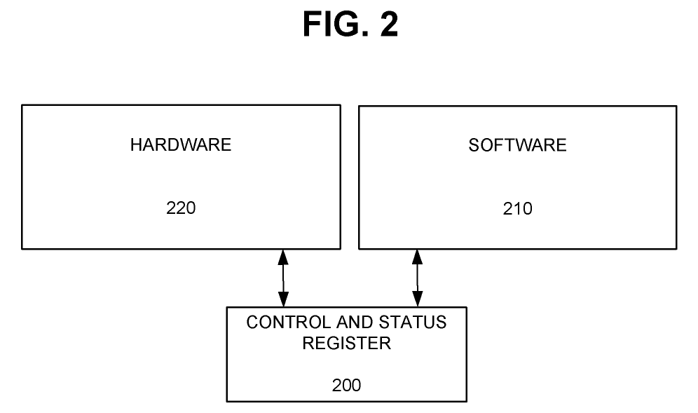

Reference is now made to FIG. 2, which illustrates an HSI such as a CSR 200. Software 210 reads and writes values to the CSR 200. This is referred to as software behavior Hardware 220 reads values in the CSR 200 and changes its own behavior according to the values. This is referred to as hardware behavior.

A behavior combination refers to hardware behavior in response to software behavior, or vice versa. As a first example of a behavior combination, an event occurs and hardware 220 sets a value in the CSR 200 and generates an interrupt. The interrupt causes software 210 to read the value in the CSR 200 and take action.

As a second example of a behavior combination, software 210 is only able to sample read a value from the CSR 200 to see what is occurring. The hardware 220 places a value into the CSR 200 so that the software 210 can read it.

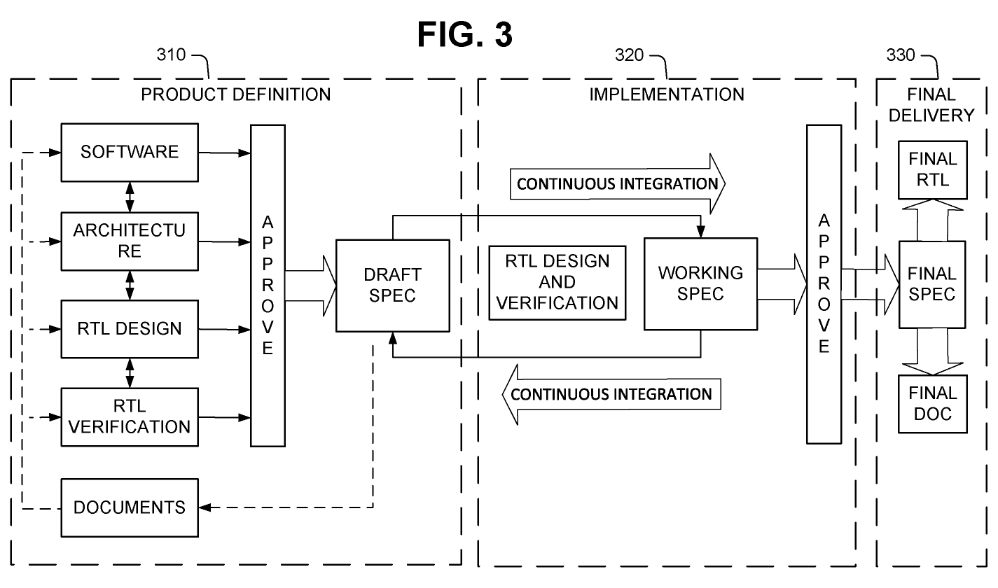

FIG. 3 shows an example of a method of generating a hardware description of a NoC. At block 310, a product is defined. An SoC architect designs a specification that includes a floorplan for the SoC, power strategy, and constraints related to the environment (e.g., clocks and their frequencies, quality of service, and type of protocol used with macros). Among other things, the floorplan defines areas on the chip for major functional blocks of the chip, including initiators and targets. The floorplan also defines blockages. It also defines the area that will be used for the inter-connect communication (that is, the “free space” for the NoC). The SoC architect may place additional constraints on the NoC. Examples of additional constraints include frequency, routing congestion, and power consumption.

A layout of the NoC is generated within the free space defined by the floorplan. Generating the layout involves placing and legalizing standard cells, and making wire connections between the NoC elements.

A hardware description of the NoC layout is generated. Register Transfer Level (RTL) may be used for design and verification flow. In addition, software is developed. Some of the software interfaces with CSRs. An RTL description may then be delivered to an SoC integrator in the form of a draft specification.

At block 320, the product definition is implemented. The SoC integrator performs integration, synthesis, and simulations to determine whether the NoC description fits into the free space defined by the floorplan, exhibits predictable results about operation frequency, and satisfies other constraints such as routing congestion, and power consumption. The integration is continuous until a working specification has been approved.

At block 330, a final specification is delivered. The final specification incudes a final RTL description and documentation.

The production definition specifies HSIs such as CSRs. A multiple input, multiple output compiler as described herein is used during product definition to reduce specification misalignments with respect to the CSRs. Reduction of the specification misalignments improves computational efficiency, as computer resources do not have to be devoted to late fixes and re-spins.

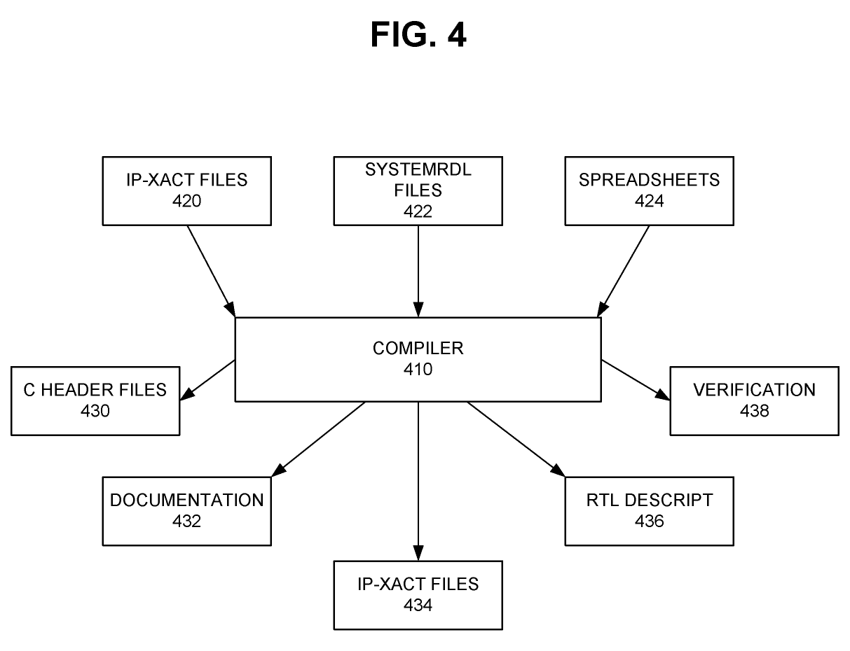

FIG. 4 shows a multiple input, multiple output compiler 410. The compiler 410 is configured to collect input files from multiple sources that describe HSIs in an electronic system such as an SoC. A complex electronic system may include millions of HSIs.

Examples of the input files include IP-XACT files 420, SystemRDL files 422, and spreadsheets 424. These input files may have different formats (e.g., RTL, SW, DV, DOC). IP-XACT, also known as IEEE 1685, is an XML format that describes individual, reusable electronic circuit designs. System RDL describes and implements a wide variety of control status registers.

The compiler 410 is further configured to determine whether data in the input files is consistent and correct with respect to the HSIs. Inconsistencies can be flagged and/or corrected.

The compiler 410 is further configured to prepare output files in different formats for different stakeholders. The following output files are provided as examples. The compiler 410 may provide C header files 430 indicating memory locations where software developers can locate their programs, and memory locations that can be used by device driver developers. The compiler 410 may provide documentation 432 that details register map and configuration settings for technical writers, system architects, and customers. The compiler 410 may provide files 434 that define and describe the HSIs in an industry standard format (e.g., IP-XACT) or other format for customers interchange. The compiler 410 may provides RTL descriptions (e.g., VHDL, Verilog) 436 for RTL designers to implement the HSIs in hardware. The compiler 410 may provide files for verifying registers and memory-mapped structures (e.g., Verilog header and UVM Register Abstraction Layer) for verification engineers.

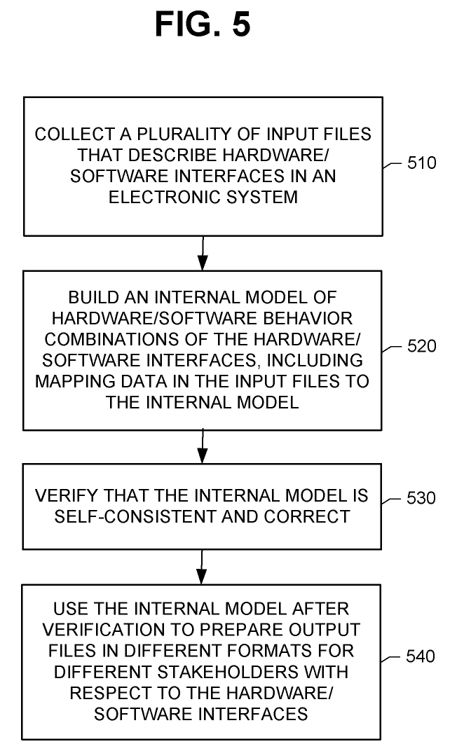

Reference is now made to FIG. 5, which illustrates a method performed by a multiple input, multiple output compiler herein for preparing files for design of hardware/software interfaces in an electronic system. At block 510, the compiler collects a plurality of input files from a corresponding plurality of multiple sources. The files describe HSIs in an electronic system. The input files are in different formats.

At block 520, the compiler builds an internal model of hardware/software behavior combinations of the HSIs. Data in the input files are mapped to the internal model.

At block 530, the compiler verifies that the internal model is self-consistent and correct. Verification may include functional, behavioral, syntactic, and semantic error checks.

At block 540, the compiler uses the internal model after verification to prepare output files in different formats for different stakeholders with respect to the HSIs.

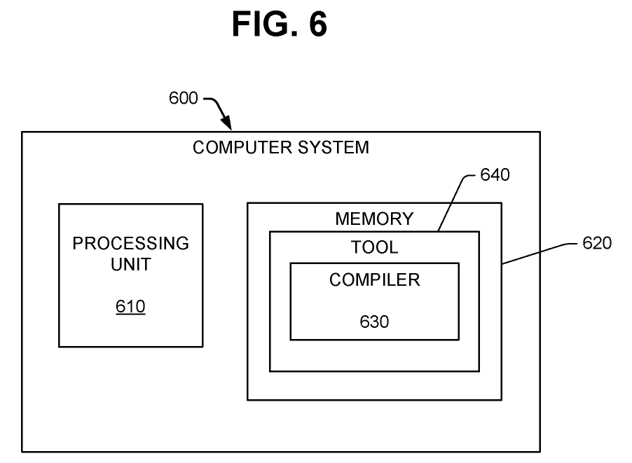

Reference is now made to FIG. 6, which illustrates a computer system 600. The computer system 600 includes a processing unit 610 and computer-readable memory 620. The computer-readable memory 620 stores a tool 640 for implementation and design of an SoC including a NoC. A compiler 630 is within the tool 640. The compiler 630 includes code that, when executed, causes the processing unit 610 to collect input files describing HSIs in the SoC and NoC, create an internal data model, use the model to determine whether data in the inputs files is consistent and correct, and use the model to prepare output files in different formats for different stakeholders with respect to the HSIs.

In some embodiments, the verification and the preparation of the output files may be performed algorithmically. In other embodiments, a machine learning model such as a large language model may be instructed to verify data in the input files and prepare the output files.

Thus disclosed is a compiler that can automate and simplify complex tasks involved in handling configuration, clock, reset, and control registers in large SoC designs. The compiler can generate code for configuration, status, interrupts, masks, counters, and other memory map registers. It can also generate data structures for SystemVerilog, C/C++, and Perl, and builds headers for firmware code. The compiler helps designers manage critical components effectively, enhancing productivity and reducing manual effort. The compiler automates the creation, validation, and integration of control and status registers in SoC designs. This eliminates the need for manual coding of these registers, which can be time-consuming and error-prone in complex systems.

Seamless integration of the compiler with the NoC enables the automatic generation of CSR components that can be integrated directly into the NoC fabric, optimizing data flow and control signal management.

The compiler enables register customization. Designers can define, customize, and manage a wide variety of CSR configurations, including read/write permissions, default values, access policies, and more. This customization enables the compiler to fit a variety of SoC designs, regardless of complexity or architecture. The compiler ensures that generated CSRs are fully compatible with other components of the SoC, including memory-mapped and peripheral devices.

The compiler is compliant with IP-XACT and other Industry Standards. This makes the compiler useful in multi-vendor environments and helps with integration into broader design ecosystems.

The compiler can generate files that are used for simulation models, test benches, and RTL descriptions that are critical for verification. This integration aids in the fast and efficient validation of CSR designs, reducing the time spent on debugging.

The compiler reduces time-to-market by automating the most labor-intensive parts of CSR configuration and generation. Accordingly, the compiler significantly reduces the time it takes to develop and integrate control and status registers into SoC designs. This leads to faster design cycles and accelerates time-to-market for complex semiconductor products.

The compiler can dramatically reduce development time and cost, especially in large SoC projects where thousands or millions of registers need to be managed. The compiler reduces the likelihood of human error, ensuring higher quality designs and smoother integration.

The compiler is scalable. Whether the design is for a small chip or a complex multi-cluster SoC, the compiler scales efficiently to manage all necessary register configurations.

The compiler also improves design reuse. Files generated by the compiler can be reused across different projects, making it easier to create derivative designs with minor modifications.

The compiler may be used for electronic systems such as automobile SoCs. These chips often require complex safety and control systems with a large number of registers. The compiler simplifies the process of managing these registers in such safety-critical designs.

The compiler can be integrated with machine learning applications for design and implementation of SoCs associated with high-performance chips used in artificial intelligence/machine learning applications, which chips have highly specialized processing elements and data flow structures. The compiler helps manage these intricate designs by automating register configuration for complex interconnects.

The compiler can be used for implementation of communications in SoCs that include NoCs, where data throughput and control are managed efficiently. The compiler ensures that register configurations are optimized for performance.

The compiler can assist with test benches and verification components, streamlining the process of ensuring the correct operation of the registers in simulation environments. If needed, the register design can be fine-tuned or customized to fit the unique needs of the project.

Certain methods, which can be implemented in a product, according to the various aspects of the invention may be performed by instructions that are stored upon a non-transitory computer readable medium. The non-transitory computer readable medium stores code including instructions that, if executed by one or more processors, would cause a system or computer to perform steps of the method described herein. The non-transitory computer readable medium includes: a rotating magnetic disk, a rotating optical disk, a flash random access memory (RAM) chip, and other mechanically moving or solid-state storage media. Any type of computer-readable medium is appropriate for storing code comprising instructions according to various example.

Some examples are one or more non-transitory computer readable media arranged to store such instructions for methods described herein. Whatever machine holds non-transitory computer readable media comprising any of the necessary code may implement an example. Some examples may be implemented as: physical devices such as semiconductor chips; hardware description language representations of the logical or functional behavior of such devices; and one or more non-transitory computer readable media arranged to store such hardware description language representations.

Certain examples have been described herein and it will be noted that different combinations of different components from different examples may be possible. Salient features are presented to better explain examples; however, it is clear that certain features may be added, modified and/or omitted without modifying the functional aspects of these examples as described.

Various examples are methods that use the behavior of either or a combination of machines. Method examples are complete wherever in the world most constituent steps occur. For example, IP elements or units include: processors (e.g., CPUs or GPUs), random-access memory (RAM – e.g., off-chip dynamic RAM or DRAM), a network interface for wired or wireless connections such as ethernet, WiFi, 3G, 4G long-term evolution (LTE), 5G, and other wireless interface standard radios. The IP may also include various I/O interface devices, as needed for different peripheral devices such as touch screen sensors, geolocation receivers, microphones, speakers, Bluetooth peripherals, and USB devices, such as keyboards and mice, among others. By executing instructions stored in RAM devices processors perform steps of methods as described herein.

Descriptions herein reciting principles, aspects, and embodiments encompass both structural and functional equivalents thereof. Elements described herein as coupled have an effectual relationship realizable by a direct connection or indirectly with one or more other intervening elements.

Practitioners skilled in the art will recognize many modifications and variations. The modifications and variations include any relevant combination of the disclosed features. Descriptions herein reciting principles, aspects, and embodiments encompass both structural and functional equivalents thereof. Elements described herein as “coupled” or “communicatively coupled” have an effectual relationship realizable by a direct connection or indirect connection, which uses one or more other intervening elements. Embodiments described herein as “communicating” or “in communication with” another device, module, or elements include any form of communication or link and include an effectual relationship. For example, a communication link may be established using a wired connection, wireless protocols, near-filed protocols, or RFID.

To the extent that the terms "including", "includes”, “having", "has", "with", or variants thereof are used in either the detailed description and the claims, such terms are intended to be inclusive in a similar manner to the term "comprising."

The scope of the invention, therefore, is not intended to be limited to the exemplary embodiments shown and described herein. Rather, the scope and spirit of present invention is embodied by the appended claims.

What is claimed is:

1. A computer-implemented method for electronic computer-aided design of an electronic system including a hardware/software interface (HSI), the method comprising:
collecting a plurality of input files from a corresponding plurality of multiple sources, wherein the input files describe the HSI in different formats;
building an internal model of hardware/software behavior combinations of the HSI, including mapping data in the input files to the internal model; and
verifying that the internal model is self-consistent and correct.

2. The method of claim 1, wherein the input files include IP-XACT files, SystemRDL files, and spreadsheets.

3. The method of claim 1, further comprising using the internal model after verification to prepare output files in different formats for different stakeholders with respect to the HSI.

4. The method of claim 3, wherein the output files are in formats for architects, technical writers, software developers, RTL designers, verification engineers, and customers interchange.

5. The method of claim 3, further comprising:
using the output files to generate a specification for a network-on-chip (NoC);
using the specification to perform RTL design and verification of the NoC until a final specification has been approved; and
using the final specification to deliver a final RTL description of the NoC.

6. The method of claim 1, wherein the HSI includes Control and Status registers.

7. The method of claim 1, wherein the internal model accounts for different combinations of software/hardware behavior of the HSI.

8. A computer system comprising:
a processing unit; and
computer-readable memory encoded with code that, when executed by the processing unit, causes the computer system to:
receive a plurality of input files about design of an electronic system including a plurality of hardware/software interfaces (HSIs);
build an internal model of hardware/software behavior combinations of the HSIs, including mapping data in the input files to the internal model; and
verify that the internal model is self-consistent and correct.

9. The computer system of claim 8, wherein the HSIs include Control and Status registers.

10. The computer system of claim 8, wherein the code, when executed, further causes the computer system to use the internal model after verification to prepare output files in different formats for different stakeholders with respect to the HSIs.

11. The computer system of claim 10, wherein the output files are in formats for architects, technical writers, software developers, RTL designers, verification engineers, and customers interchange.

12. The computer system of claim 10, wherein the code, when executed, further causes the computer system to:
use the output files to generate a specification for a network-on-chip (NoC) ;
use the specification to perform RTL design and verification of the NoC until a final specification has been approved; and
use the final specification to deliver a final RTL description of the NoC.

13. The computer system of claim 8, wherein the internal model accounts for different combinations of software-hardware behavior of the HSIs.

14. A compiler within a tool for implementation and design of a system-on-chip (SoC) and a network-on-chip (NoC), wherein the tool includes a non-transitory computer readable medium for storing code, which when executed by one or more processors, causes the tool to:
receive, as input, data about control and status registers (CSRs), including at least access permissions, reset values, and properties;
generate register transfer level (RTL) code for the CSRs;
generate documentation that details register map and configuration settings for the CSRs; and
integrate the RTL code into an SoC design and NoC design, wherein the tool ensures compatibility with memory maps, and generates components for RTL verification.

15. The compiler of claim 14, wherein the compiler is configured to:
build an internal model of hardware/software behavior combinations of the CSRs, including mapping data in the files to the internal model;
verify that the internal model is self-consistent and correct; and
use the internal model to generate the RTL code and the documentation.

16. The compiler of claim 15, wherein the internal model accounts for different combinations of software/hardware behavior of the CSRs.

17. The compiler of claim 14, wherein the data is in the form of IP-XACT files, SystemRDL files, and spreadsheets.

18. The compiler of claim 14, wherein integrating the RTL code includes performing continuous RTL design and verification.
